(19) United States
(12) Patent Application Publication
(10) Pub. No.: US 2025/0159087 A1
(43) Pub. Date: May 15, 2025

(54) READING DEVICE, IMAGE FORMING SYSTEM, AND NON-TRANSITORY RECORDING MEDIUM STORING COMPUTER READABLE CONTROL PROGRAM

(71) Applicant: Konica Minolta, Inc., Tokyo (JP)

(72) Inventor: Mitsunori NAKAMURA, Tokyo (JP)

(21) Appl. No.: 18/932,122

(22) Filed: Oct. 30, 2024

(30) Foreign Application Priority Data
Nov. 9, 2023 (JP) 2023-191339

(51) Int. Cl. H04N 1/00; G06F 3/12

(52) U.S. Cl. CPC H04N 1/00806; G06F 3/1208; G06F 3/1256; H04N 1/00591; H04N 1/00724; H04N 1/00745; H04N 1/00816

(57) ABSTRACT

A reading device includes a reader provided with a reading sensor that optically reads a sheet conveyed through a conveyance path, and a hardware processor that controls the reader, in which the reader includes a background section that is disposed to face the reading sensor across the conveyance path, the background section having a background surface serving as a background of the sheet when the sheet is read, and the hardware processor switches the background surface of the background section on the basis of attribute information of the sheet to be conveyed.

### CROSS-REFERENCE TO RELATED APPLICATION

The entire disclosure of Japanese patent application No. 2023-191339, filed on Nov. 9, 2023, is incorporated herein by reference in its entirety.

### BACKGROUND OF THE INVENTION

### 1. Technical Field

The present invention relates to a reading device, an image forming system, and a non-transitory recording medium storing a computer readable control program.

### 2. Description of Related Art

In an image forming apparatus, there is a technique for detecting the size of a sheet and correcting an image in accordance with the detected size (for example, Patent Literature 1 (Japanese Unexamined Patent Application Publication No. 2014-238544)). In the image forming apparatus disclosed in Patent Literature 1, a size measuring section is disposed at a position sufficiently upstream of an image former, so that the correction for image position set based on the measurement result of the size measuring section is reflected on the detected sheet.

Furthermore, in Patent Literature 1, a contact image sensor (CIS) that measures a sheet width as a size measuring section detects positions of side ends of a sheet (the position of a right end and the position of a left end in a conveyance direction). Thus, the sheet width is measured (paragraph 0013).

### SUMMARY OF THE INVENTION

There are various types of sheet used in the image forming apparatus, and for example, dark-colored sheet other than white sheet may be used. When a colored sheet is used, the above-described image forming apparatus that detects the positions of both side ends of the sheet by the CIS may not accurately detect the positions of side ends of the colored sheet due to insufficient contrast at the positions of the ends.

The present invention has been made in view of the above circumstances, and an object thereof is to provide a reading device capable of accurately detecting a sheet size or a sheet shape.

To achieve at least one of the abovementioned objects, according to an aspect of the present invention, a device reflecting one aspect of the present inventions comprises the followings.

A reading device including:
a conveyor that conveys a sheet through a conveyance path;
a reader provided with a reading sensor that optically reads the sheet conveyed through the conveyance path; and
a hardware processor that controls the reader, wherein
the reader includes a background section that is disposed to face the reading sensor across the conveyance path, the background section having a background surface serving as a background of the sheet when the sheet is read, and
the hardware processor switches the background surface of the background section on the basis of attribute information of the sheet to be conveyed.

### BRIEF DESCRIPTION OF THE DRAWINGS

The advantages and features provided by one or more embodiments of the present invention will be more fully understood from the following detailed description and the accompanying drawings. However, these are for purposes of illustration only and are not intended to limit the present invention.

FIG. 1 is a diagram illustrating a schematic configuration of an image forming apparatus including a reading device according to the present embodiment;

FIG. 2 is a block diagram illustrating a hardware configuration of an image forming system;

FIGS. 3A and 3B are schematic diagrams illustrating a main configuration of a reader in a first embodiment;

FIG. 4 is a schematic diagram illustrating a main configuration of the reader;

FIG. 5 is a table for describing use conditions of surfaces of a background section;

FIG. 6 is a table for describing use conditions of surfaces of the background section;

FIG. 7 is a flowchart illustrating processing of switching a background surface and printing processing in the first embodiment;

FIG. 8 is a subroutine flowchart illustrating processing of step S12 in FIG. 7;

FIG. 9 illustrates an example of a print job;

FIGS. 10A and 10B are schematic diagrams illustrating a main configuration of a reader in a second embodiment;

FIG. 11 is a table for describing use conditions of surfaces of a background section;

FIG. 12 is a flowchart illustrating processing of switching a background surface and printing processing in the second embodiment; and

FIG. 13 is a subroutine flowchart illustrating a process of step S32 in FIG. 12.

### DETAILED DESCRIPTION

Embodiments of the present invention will be described below with reference to the accompanying drawings. It is to be noted that the scope of the present invention is not limited to the embodiments to be described. Note that in the description of the drawings, the same components are denoted by the same reference signs, and redundant descriptions will not be repeated. In addition, dimensional ratios in the drawings are exaggerated for convenience of description and may be different from actual ratios. In the drawings, a top-bottom direction (vertical direction) is defined as a Z direction, a front direction and a rear direction of an image forming system or a reading device are defined as a Y direction, and a direction orthogonal to the Y and Z directions is defined as an X direction. The X direction is also referred to as a conveyance direction of a sheet. The Y direction is also referred to as a width direction. In the present embodiment, the sheet includes a printing sheet (hereinafter simply referred to as sheet) and various films.

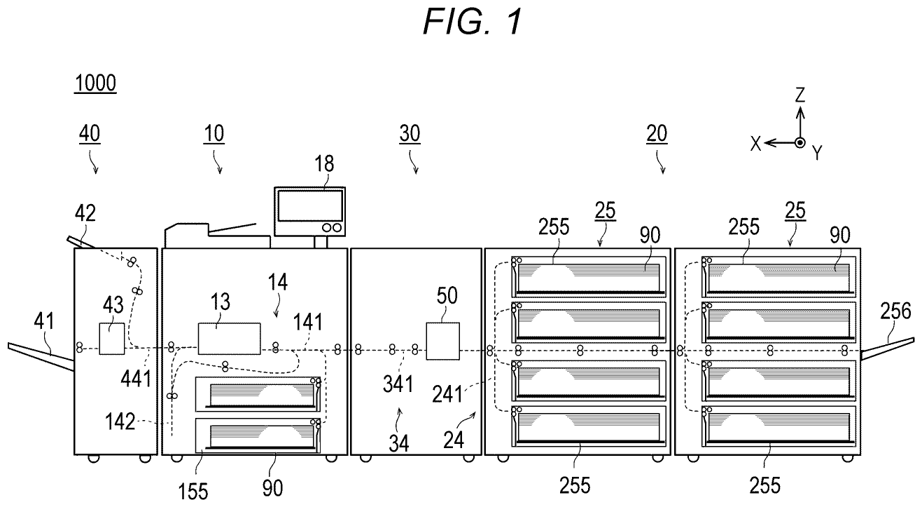

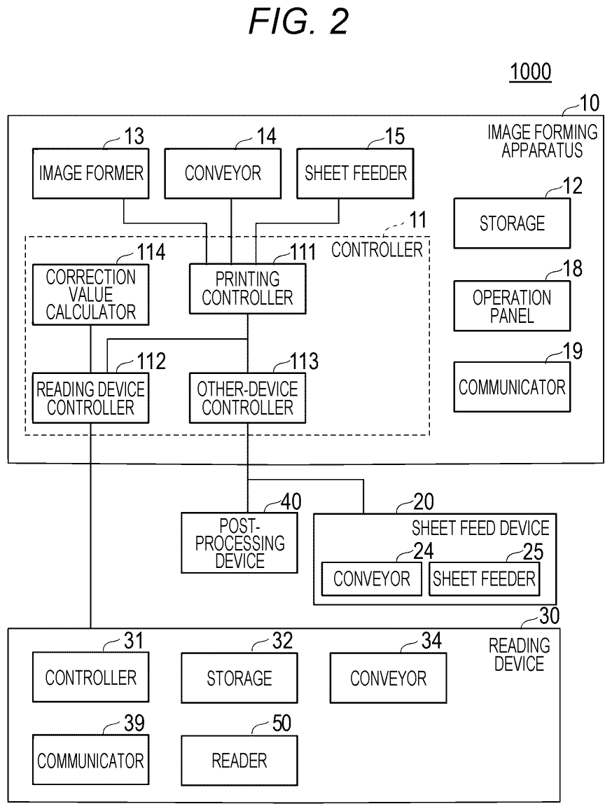

FIG. 1 is a diagram illustrating a schematic configuration of an image forming system 1000 including a reading device 30 according to the present embodiment. FIG. 2 is a block diagram illustrating a hardware configuration of the image forming system 1000. As illustrated in FIG. 1, the image forming system 1000 includes an image forming apparatus 10, a sheet feed device 20, a reading device 30, and a post-processing device 40, which are mechanically and electrically connected to each other.

### (Image Forming Apparatus 10)

The image forming apparatus 10 forms an image on a sheet 90 fed from the sheet feed device 20 on the upstream side and sent via the reading device 30. Further, the image forming apparatus 10 forms an image on a sheet 90 fed from a sheet feeder of the image forming apparatus 10.

The image forming apparatus 10 includes a controller 11 (hardware processor), a storage 12, an image former 13, a conveyor 14, a sheet feeder 15, an operation panel 18, a communicator 19, and the like. These components are connected to each other via a signal line such as a bus for exchanging signals. Note that in FIG. 2, connection signal lines to some constituent elements such as the storage 12 and the operation panel 18 in the image forming apparatus 10 are not illustrated (connection to a controller 31 or the like of the reading device 30 to be described later is similarly not illustrated).

### (Controller 11)

The controller 11 includes a CPU, a ROM, a RAM, and the like. The controller 11 executes various kinds of processing by executing programs stored in the ROM and the storage 12 described later, and controls components of the apparatus and executes various kinds of calculation processing in accordance with the programs. The controller 11 functions as a printing controller 111, a reading device controller 112, an other-device controller 113, and a correction value calculator 114. The functions of these sub-controllers 111 to 114 will be described later.

### (Storage 12)

The storage 12 includes an auxiliary storage such as a hard disk that stores various kinds of programs and various kinds of data. Further, the storage 12 stores sheet information regarding the sheets stored in each of sheet feed trays (trays 155, 255, 256, etc. to be described below) in association with the corresponding tray. The sheet information includes information regarding the brand, size (sheet width, sheet length), color, basis weight (weight), and type (gloss coated paper, matt coated paper, plain paper, high-quality paper, rough paper, etc.) of the sheet. In addition, the storage 12 may store a sheet brand, a determination model (determination model algorithm) used for determining a control parameter, and a paper profile.

### (Image Former 13)

The image former 13 forms an image by, for example, an electrophotographic method. The image former 13 includes writing sections (laser exposure sections) and photosensitive drums respectively corresponding to basic colors of yellow (Y), magenta (M), cyan (C), and black (K), and developing devices each accommodating a two-component developer including toner of the corresponding color and a carrier. The image former 13 further includes an intermediate transfer belt, a secondary transferer, and a fixer. Toner images formed on the photosensitive drums by the developing devices of the respective colors are superimposed on the intermediate transfer belt, and are transferred onto the conveyed sheet 90 at the secondary transferer. The toner image on the sheet 90 is fixed on the sheet 90 by being heated and pressed by the fixer on a downstream side.

### (Conveyor 14, Sheet Feeder 15)

The conveyor 14 includes conveyance paths 141, 142, and the like. The sheet feeder 15 includes a plurality of sheet feed trays 155. The conveyance path 141 includes a plurality of conveyance roller pairs provided along the conveyance path and a drive motor (not illustrated) that drives the conveyance roller pairs. The sheet feeder 15 includes a delivery roller that delivers an uppermost sheet of a plurality of sheets 90 loaded and placed in the sheet feed tray 155, and delivers the sheets 90 in the sheet feed tray to a conveyance path on the downstream side one by one. A conveyance path 341 of the reading device 30 is connected to the upstream side of the conveyance path 141.

The conveyor 14 conveys the sheet 90 fed from the sheet feed tray 155 and the like. The sheet 90 conveyed on the conveyance path 141 is subjected to image formation by the image former 13, and then ejected onto a sheet ejection tray 41 via the subsequent post-processing device 40. In double-sided printing in which an image is also formed on a back surface (second surface) of the sheet 90, the sheet 90 on which an image has been formed on one side is conveyed to the conveyance path 142 for double-sided image formation in a lower portion of the apparatus body. The sheet 90 conveyed to the conveyance path 142 is turned over on a switchback path and then conveyed to the conveyance path 141 for single-sided printing, and an image is again formed on the other side of the sheet 90 by the image former 13.

### (Operation Panel 18, Etc.)

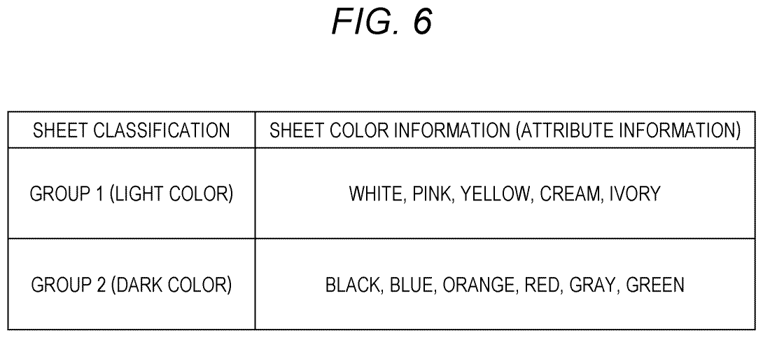

The operation panel 18 includes a touch screen, a numeric keypad, a start button, a stop button, and the like. The operation panel 18 displays a state of the image forming apparatus 10 or the image forming system 1000, and is used to input various settings and instructions from a user. The user can set, through a setting screen of the operation panel 18, information regarding the type and color of sheets loaded in the sheet feed trays 155, 255, and the like (see FIG. 6 described later). Furthermore, the user can make the following settings through the setting screen of the operation panel 18 or a setting screen of a print setting application that runs on a personal computer (PC) communicably connected to the image forming system 1000 (hereinafter, referred to as operation panel or the like).

The user can set, as a print setting,
(1) the size of sheet to be used,
(2) color information regarding the color of the sheet,
(3) enabled/disabled for sheet image correction position, and the like. Note that in the following, the sheet size and color information of the sheet are also referred to as attribute information of the sheet.

The communicator 19 is an interface for communicating with a PC or other devices 20, 30, or the like.

### (Sub-Controllers 111 to 114)

When receiving a print job, the printing controller 111 executes the print job on the basis of print job setting information of the input print job. The print job is input in response to an instruction sent from the operation panel 18 or an external terminal such as a network-connected PC operated by the user.

The printing controller 111 controls feeding and conveyance of the sheet 90 by controlling the conveyor 14 (including the conveyance paths 141 and 142 and the drive motors for the fixer, and the like) and the sheet feeder 15. Furthermore, the printing controller 111 instructs the reading device controller 112 to read the sheet 90 on which an image has not yet been formed (reading instruction) in accordance with the setting of the print job (setting of enabling image position correction). Further, the printing controller 111 controls the image former 13 to control the image formation timing and adjust vertical and horizontal magnifications according to image forming conditions and a sheet position based on a sheet position correction value calculated by a correction value calculator 114 to be described later. In the following, the control of the image formation timing with the sheet position correction value and the adjustment of the vertical and horizontal magnifications are referred to as position correction control.

As described below, the position correction control is performed on at least one of the first surface (front surface) and the second surface (back surface) according to at least the arrangement position of the reader 50. The arrangement conditions of the reader 50 vary depending on the conveyance path length or the conveyance speed of the reading device 30, or connection of another device between the reading device 30 and the image forming apparatus 10.

### (1) Arrangement Condition Possible for Both the First Surface and the Second Surface

For example, when the arrangement condition of the reader 50 is that the reader 50 is located sufficiently upstream of the image former 13, and the image correction can be performed in time as in, for example, Japanese Unexamined Patent Publication No. 2014-238544, the position correction control of the sheet 90 that has been read is performed.

Specifically, in a case where the reader 50 is disposed in a positional relationship in which (b) comes after (a) described below, the position correction control is performed when an image is formed on the first surface and/or the second surface of the sheet 90 that has been read: (a) a timing at which preparation for image formation reflecting the position correction control is completed from image data (hereinafter, referred to as read data) obtained by the reader 50 of the reading device 30 reading the sheet 90; and (b) a timing at which the image formation on the sheet 90 is started.

### (2) Arrangement Condition Possible for Only Second Surface

When the arrangement condition of the reading device 30 is that the reading device 30 is located at a position where the image correction cannot be performed in time, the following control is performed. In order to register images on the front and back surfaces, image formation reflecting the position correction control is performed at the time of image formation on the second surface (back surface) during double-sided image formation for the read sheet 90.

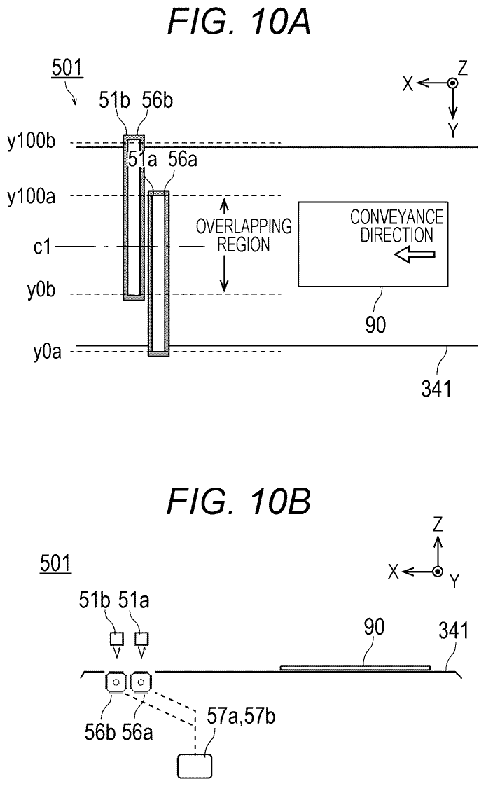

The reading device controller 112 controls the reading device 30 in response to an execution instruction request (reading instruction) from the printing controller 111. In response to the execution instruction request, the reading device 30 causes the reader 50 and other various sensors included in the reading device 30 to measure the sheet characteristics. Furthermore, when the sheet 90 is read by the reading device 30, the reading device controller 112 acquires the read data generated by the reading device 30. The read data is read data generated by one reader 50 or read data obtained by combining two pieces of data obtained by reading by two readers 50 (see FIGS. 10A and 10B described later).

The other-device controller 113 controls the sheet feed device 20 and the post-processing device 40. Specifically, the other-device controller 113 communicates with the sheet feed device 20 to transmit and receive a sheet feed tray to be used, a sheet conveyance timing, and the like. Specifically, the other-device controller 113 transmits, to the post-processing device 40, a sheet conveyance timing, information regarding setting of post-processing for the sheet to be conveyed, and the like.

The correction value calculator 114 acquires the read data obtained by reading the sheet 90 on which an image has not yet been formed from the reading device controller 112. Then, the correction value calculator 114 recognizes the ends of the sheet 90 from the acquired read data to detect the characteristics of the length of each of the sides (vertical and horizontal sides) or the shape of the sheet 90. Hereinafter, the detected characteristics are also simply referred to as “sheet size”. The correction value calculator 114 calculates an image position correction value from a difference between the detected sheet size and the sheet size in the print setting. The calculated image position correction value is sent to the printing controller 111. As described above, the printing controller 111 performs the position correction control according to the sheet position on the basis of the image position correction value.

### (Sheet Feed Device 20)

As illustrated in FIGS. 1 and 2, the sheet feed device 20 includes a conveyor 24 and a sheet feeder 25. In addition, the sheet feed device 20 includes a controller, a storage, and a communicator (none of which are illustrated) in addition to the conveyor 24 and the sheet feeder 25, and these components are connected to each other via a signal line such as a bus for exchanging signals.

The sheet feeder 25 includes a plurality of sheet feed trays 255 and a manual sheet feed tray 256. The sheet feed trays 255 are automatically numbered from tray 1 to tray n based on a predetermined rule. The conveyor 24 and the sheet feeder 25 have the same functions as those of the conveyor 14 and the sheet feeder 15, feed the sheets 90 placed on the sheet feed trays 255 or the like one by one, and convey the sheets 90 to the conveyance path 241. The conveyance path 241 is connected to the subsequent conveyance path 341. The sheet 90 fed from each of the sheet feed trays 245 and the like and conveyed on the conveyance path 241 is conveyed to the reading device 30 on the downstream side, and is subjected to the measurement of the sheet characteristics such as the sheet size or image formation by the image forming apparatus 10 on the further downstream side.

### (Post-Processing Device 40)

The post-processing device 40 performs post-processing on the sheet 90 sent from the image forming apparatus 10 or ejects the sheet 90 according to the setting of the print job. The post-processing device 40 includes sheet ejection trays 41 and 42, a post-processor 43, and a conveyance path 441. In addition, the post-processing device 40 includes a controller, a storage, a conveyor, and a communicator (none of which are illustrated), and these components are connected to each other via a signal line such as a bus for exchanging signals. The sheet ejection trays 41 and 42 are selected in accordance with the setting of the print job. The conveyance path 441 is connected to the conveyance path 141 on the upstream side. The post-processor 43 performs at least one of stapling, punching, cutting, folding, or bookbinding on the sheet 90 on which an image has been formed.

### (Reading Device 30)

Next, the reading device 30 will be described. As illustrated in FIG. 2, the reading device 30 includes a controller 31, a storage 32, a conveyor 34, a communicator 39, the reader 50, and the like. The controller 31, the storage 32, the conveyor 34, and the communicator 39 have the same hardware configuration as the controller 11, the storage 12, the conveyor 14, and the communicator 19, respectively, of the image forming apparatus 10 described above, and thus the description thereof is omitted.

### (Reader 50)

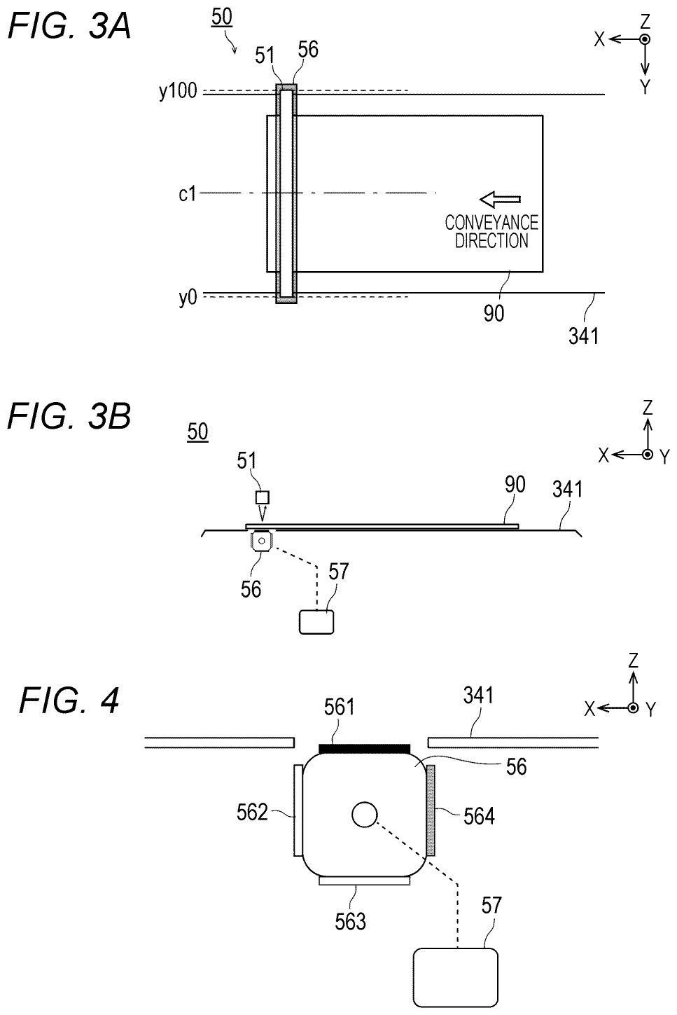

The outline of the reader 50 will be described below with reference to FIGS. 3A to 6. FIGS. 3A, 3B and 4 are schematic diagrams illustrating a main configuration of the reader 50. FIG. 3A is a top view, and FIG. 3B is a side view. The reader 50 includes at least one reading sensor 51, at least one background section 56, and a switching mechanism 57. The reading sensor 51 is a one-dimensional line sensor including a plurality of photoelectric conversion elements arranged in the Y direction, and reads a one-dimensional image. The reading sensor 51 also includes optical elements such as light emitting elements or lens arrays arranged along the line of the photoelectric conversion elements. During reading, the light emitting elements emit light that is uniform in an extending direction of the line toward the sheet 90 on the conveyance path 341. The reader 50 reads the sheet 90, whereby read data corresponding to one sheet is generated.

The background section 56 has a prismatic shape having a polygonal cross section and an axis extending in the Y direction. In the example illustrated in FIG. 4 and the like, the background section 56 has a quadrangular prism shape having four surfaces 561 to 564. The switching mechanism 57 includes a rotation mechanism such as a drive source and a gear, and switches the background surface facing the reading sensor 51 by controlling the rotation position of the background section 56. For example, the switching mechanism 57 including a servo motor or a stepping motor rotates the background section 56 around the rotation axis by a predetermined angle (an integral multiple of 90 degrees) and stops the background section 56 at that position.

As illustrated in FIGS. 3B and 4, the background section 56 is disposed to face the reading sensor 51 across the conveyance path 341. The background section 56 is placed in a cutout portion of a lower guide plate constituting the conveyance path 341. The surface facing the reading sensor 51 among the four surfaces 561 to 564 of the background section 56 is switched by the switching mechanism 57.

Note that the configuration of the background section 56 is not limited to the example illustrated in FIG. 4 and the like, and any other configuration may be employed. For example, four surfaces are arranged in the X direction on the background section 56 having a plate shape. Then, the surface facing the reading sensor 51 is switched by sliding forward or backward the background section 56 by a predetermined amount in the X direction by the switching mechanism 57. As another example, the background section 56 may be configured by a device, such as electronic paper, which can electronically switch the density of the display surface. In this case, the density (brightness) of the surface facing the reading sensor 51 is switched by electrical control.

As illustrated in FIG. 3A, a reading region of the reading sensor 51 ranges from y0 to y100 in the Y direction, and is wider than the width of the maximum sheet 90 that can be conveyed in the image forming system 1000. In addition, in the Y direction, a center cl of the conveyance of the sheet 90 and a center cl of the reading region of the reading sensor 51 are aligned with each other.

### (Background Surfaces 1 and 2, Sheet Passing Surface, Etc.)

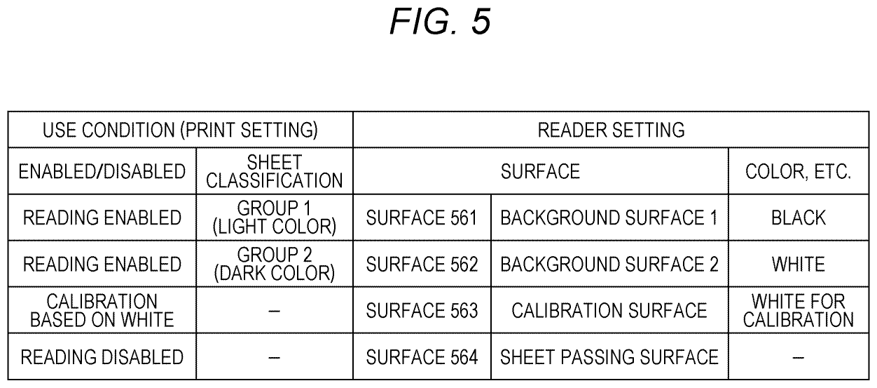

FIGS. 5 and 6 are tables for describing use conditions of the surfaces 561 to 564 of the background section 56. These tables are stored in advance in the storage 12 or the storage 32. Background surfaces 1 and 2 (surfaces 561 and 562) are surfaces used when the reading by the reader 50 is set as enabled.

The surface 561 is black or has a color having brightness equal to or less than a predetermined value (for example, having L* of the CIELAB color space equal to or less than 20). The surface 561 is a first background surface (hereinafter, also referred to as “background surface 1”) serving as a background of the sheet 90 when the sheet 90 is read by the reading sensor 51. As illustrated in FIGS. 5 and 6, background surface 1 is used when the color information regarding the color of the sheet 90 to be read indicates a light color included in a first group and having a brightness difference from the surface 561 larger than a predetermined value.

The surface 562 is white or has a color having brightness equal to or more than a predetermined value (for example, having L* of the CIELAB color space equal to or less than 70). The surface 562 is a second background surface (hereinafter, also referred to as “background surface 2”) serving as a background of the sheet 90 when the sheet 90 is read by the reading sensor 51. As illustrated in FIGS. 5 and 6, background surface 2 is used when the color information regarding the color of the sheet 90 to be read indicates a dark color included in a second group and having a brightness difference from the surface 562 equal to or greater than a predetermined value.

The surface 563 is a calibration surface used for calibration of the reading sensor 51 periodically performed at a predetermined timing of the reading sensor 51. For example, the surface 563 is formed to have a white color in a defined range and is used for adjustment of white balance and a white level.

The surface 564 is used when reading is not performed (reading is set as disabled), and functions as a sheet passing surface that closes the cutout portion of the lower guide plate of the conveyance path 341 at the time of sheet passing.

### (Processing of Switching Background Surface and Printing Processing)

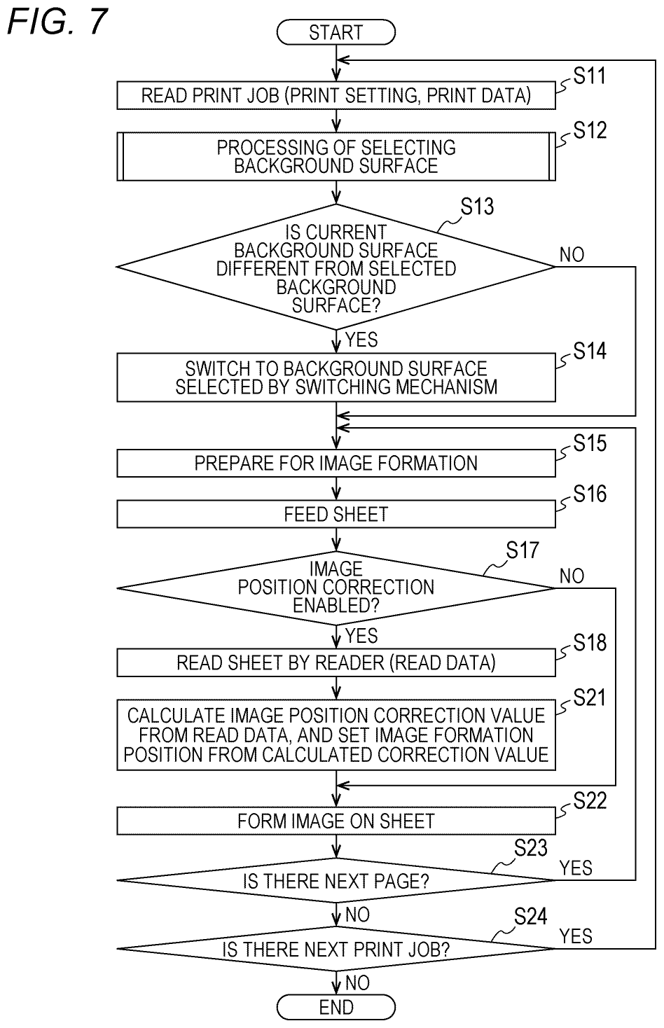

Next, processing of switching the background surface and printing processing that are executed in the image forming system 1000 according to the first embodiment will be described with reference to FIG. 7 to FIG. 9.

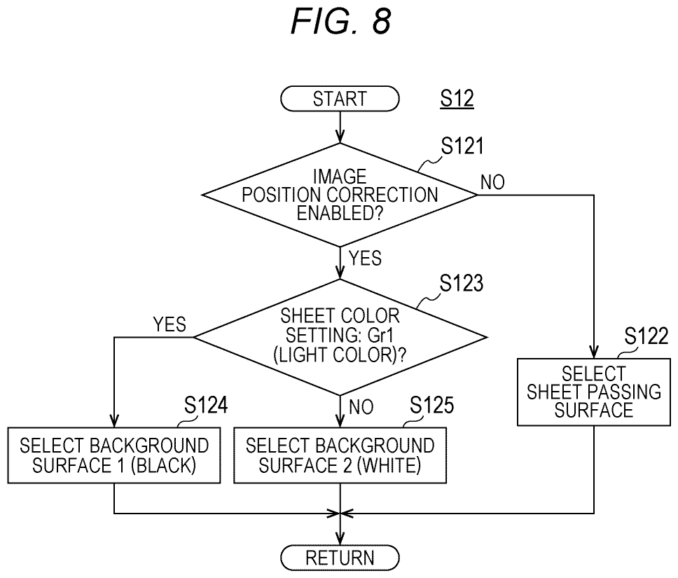

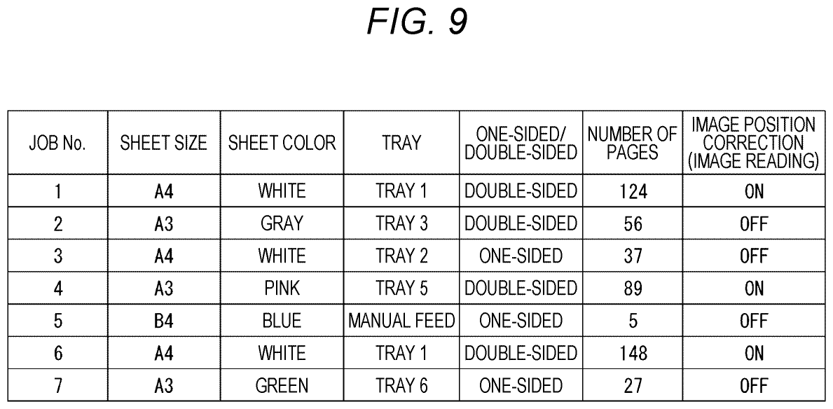

FIG. 7 is a flowchart illustrating processing of switching the background surface executed by the reading device 30 and printing processing executed by the image forming system 1000. FIG. 8 is a subroutine flowchart illustrating the processing of step S12 in FIG. 7. FIG. 9 is an example of a print job to be executed.

### (Step S11)

The printing controller 111 of the controller 11 reads the first print job in a print job reservation list. In the example illustrated in FIG. 9, the first job 1 is read. The print job includes a print setting and print data (document image data). As illustrated in FIG. 9, the print setting includes at least sheet color (sheet attribute information) and setting of whether to enable or disable image position correction.

### (Step S12)

The printing controller 111 performs processing of selecting the background surface based on the print setting. This processing will be described with reference to the subroutine flowchart in FIG. 8.

### (Step S121)

The printing controller 111 determines whether or not the image position correction is enabled with reference to the print setting. The printing controller 111 advances the processing to step S122 when the image position correction is set as disabled, and advances the processing to step S123 when it is set as enabled. In the example of job 1 in FIG. 9, the image position correction is set as “enabled”.

### (Step S122)

The printing controller 111 selects the sheet passing surface (surface 564).

### (Step S123)

The printing controller 111 acquires the sheet color (sheet information) in the print setting, and determines whether the sheet color belongs to group 1 (light color) or group 2 (dark color) with reference to the table in FIG. 6. The printing controller 111 advances the processing to step S124 when the sheet color belongs to group 1, and advances the processing to step S125 when it does not belong to group 1 (when it belongs to group 2).

### (Step S124)

The printing controller 111 selects background surface 1 (black) (surface 561). For example, in the example of job 1 in FIG. 9, the sheet color is white (group 1), and thus, background surface 1 (black) is selected.

### (Step S125)

The printing controller 111 selects background surface 2 (white) (surface 562). When the sheet color is, for example, black or blue (group 2), background surface 2 (white) is selected. Thus, the printing controller 111 ends the processing in FIG. 8 and returns to processes in step S13 and subsequent steps in FIG. 7.

### (Step S13)

The printing controller 111 acquires the setting information on the current background surface from the reading device controller 112, and determines whether or not the current background surface (or surface) is different from the background surface selected in step S12. The printing controller 111 advances the processing to step S15 when the two background surfaces are the same, and advances the processing to step S14 when they are different.

### (Step S14)

The printing controller 111 controls the switching mechanism 57 by the controller 31 through the reading device controller 112 to switch the background surface to the one selected in step S12. For example, when the sheet passing surface is selected in step S122, the background surface is switched to the sheet passing surface, and when background surface 1 is selected in step S124, the background surface is switched to background surface 1.

### (Step S15)

The printing controller 111 reads the print data of the designated page on the basis of the print setting, and transmits an instruction for preparing image formation for the next sheet 90 to the image former 13.

### (Step S16)

The printing controller 111 transmits, to the sheet feeder 25 of the sheet feed device 20 via the other-device controller 113, an instruction to start feeding the next sheet 90 from the sheet feed tray 255 designated in accordance with the print setting. The sheet feeder 25 feeds the sheet 90 from the designated sheet feed tray 255 and conveys the sheet 90 through the conveyance path 241. For example, in the example of job 1 in FIG. 9, the sheet 90 is fed from tray 1.

### (Step S17)

The printing controller 111 determines whether or not the image position correction is enabled with reference to the print setting. The printing controller 111 advances the processing to step S22 when the image position correction is set as disabled, and advances the processing to step S18 when it is set as enabled. In the example of job 1 in FIG. 9, the image position correction is set as “enabled”.

### (Step S18)

The printing controller 111 instructs the reading device 30 to read the sheet 90 before image formation through the reading device controller 112. The reader 50 reads the designated sheet 90 at the timing at which the sheet 90 is conveyed to the reading region of the conveyance path 341, and generates read data (image data).

### (Step S21)

The reading device controller 112 acquires the read data generated by the reading process in step S21 from the reading device 30 and temporarily stores the read data in the storage 12. Then, the reading device controller 112 gives the temporarily stored read data to the correction value calculator 114. The correction value calculator 114 recognizes the ends of the sheet 90 from the read data, and recognizes the lengths of the four sides or the shape of the sheet 90. In this case, during the reading process in step S18, the background surface disposed to face the reading sensor 51 (reading sensor) and serving as the background of the sheet 90 when the sheet 90 is read is set to a background surface of a color having high contrast with the sheet color of the sheet 90. Therefore, the correction value calculator 114 can accurately recognize the ends of the sheet 90 from the read data.

The correction value calculator 114 recognizes the sheet size from the recognized lengths of the four sides or shape, and calculates an image position correction value from the difference between the recognized sheet size and the sheet size in the print setting.

The correction value calculator 114 gives the calculated image position correction value to the printing controller 111 via the reading device controller 112. In job 1 illustrated in FIG. 9, the printing controller 111 uses the calculated image position correction value as a correction value for the image formation position on the back surface (second surface) to register the images on the front and back surfaces (first and second surfaces). The printing controller 111 gives and sets the image position correction value to the image former 13. The image former 13 performs the above-described correction according to the set image position correction value.

### (Step S22)

The printing controller 111 transmits an image forming instruction for the next sheet 90 to the image former 13. The image former 13 forms an image on a sheet surface on the basis of the instructed print data. When this image is formed, the image position on at least one of the first surface and the second surface is finely adjusted on the basis of the image position correction value.

### (Step S23)

When there is a next page in the print job being executed as a result of checking the print setting, the printing controller 111 returns the processing to step S15 and repeats the subsequent processes. On the other hand, when the next page is not present, the printing controller 111 advances the processing to step S24.

### (Step S24)

When there is a next print job as a result of checking the print job reservation list, the printing controller 111 returns the processing to step S11 and repeats the subsequent processes. On the other hand, when the next print job is not present, the printing controller 111 ends the processing (END).

As described above, the reading device or the image forming system according to the present embodiment includes: a reading sensor that optically reads a sheet conveyed through a conveyance path; and a reader including a background section that is disposed to face the reading sensor across the conveyance path, the background section having a background surface serving as a background of the sheet when the sheet is read. Furthermore, the reading device or the image forming system includes a controller that switches the background surface of the background section on the basis of attribute information of the sheet to be conveyed. With such a configuration, even in a case where sheets of various colors are used, the edge position can be accurately detected, and thus the sheet shape can be accurately detected.

### Second Embodiment

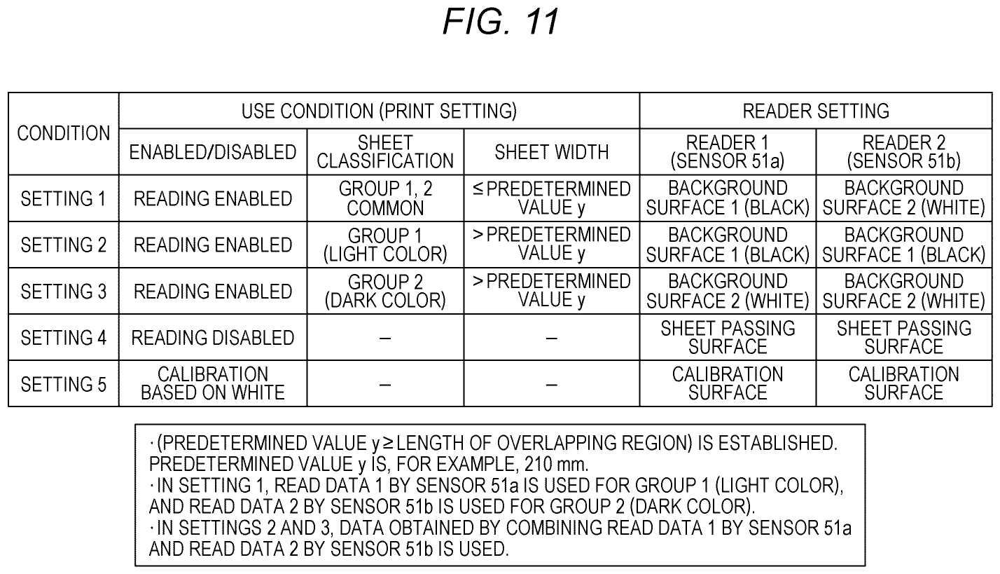

Next, a reading device 30 and an image forming system 1000 according to a second embodiment will be described with reference to FIGS. 10A to 13. FIGS. 10A and 10B are schematic diagrams illustrating a main configuration of a reader 501 in the second embodiment. FIG. 11 is a table for describing use conditions of surfaces of a background section.

As illustrated in FIGS. 10A and 10B, the reader 501 includes two sets of reading sensors 51a and 51b and background sections 56a and 56b. In the first embodiment, the reading sensor 51 having a reading region (y0 to y100 in FIG. 3A) wider than the maximum sheet size is used. In the second embodiment, two reading sensors 51a and 51b each having a reading region narrower than the maximum sheet size, for example, having a reading region of 297 mm, are used. Both pieces of read data read by the reading sensors 51a and 51b are combined to achieve reading of a sheet having the maximum sheet width. Such two reading sensors 51a and 51b are used mainly from the viewpoint of marketability and cost.

Except for the lengths in the Y direction, each of the reading sensors 51a and 51b has the same configuration as the reading sensor 51 in the first embodiment. Each of the background sections 56a and 56b is the same as the background section 56 and has surfaces 561 to 564 (refer to FIG. 4). Further, each of the switching mechanisms 57a and 57b has the same configuration as the switching mechanism 57 in the first embodiment. The background section 56a is disposed to face the reading sensor 51a and the background section 56b is disposed to face the reading sensor 51b across the conveyance path 341. In the following, a set of the reading sensor 51a and the background section 56a is also collectively referred to as “reader 1”, and a set of the reading sensor 51b and the background section 56b is also collectively referred to as “reader 2”. The reading sensor 51a and the reading sensor 51b are disposed adjacent to each other in the X direction (conveyance direction) with an interval of, for example, about several mm, and are disposed to be shifted from each other so as to at least partially vary in the reading region in the Y direction (width direction). The reading region of the reading sensor 51a in the Y direction is within the range from y0a to y100a, and the reading region of the reading sensor 51b is within the range from y0b to y100b. An overlapping region where both reading regions overlap each other is within the range from y0b to y100a. A center cl of the overlapping region and a center cl of conveyance of the sheet 90 are aligned with each other in the Y direction. Here, the length of the overlapping region in the Y direction is set to be equal to or greater than a predetermined value y. For example, the predetermined value y is 210 mm, and the length of the overlapping region is the same as or longer than the predetermined value y by several mm to several tens of mm.

FIG. 11 is a table for describing use conditions of surfaces 561 to 564 of the background section 56. These tables are stored in advance in the storage 12 or the storage 32. In these tables, groups 1 and 2 are classified based on the sheet information described in the print setting (FIG. 6). In setting 1, the background surfaces of readers 1 and 2 are a combination having a predetermined brightness difference (a combination of background surface 1 and background surface 2). In group 1 (light color), the read data (hereinafter, referred to as read data 1) obtained by the reading of the reading sensor 51a set to background surface 1 (black) is used. In group 2 (dark color), the read data (hereinafter, referred to as read data 2) obtained by the reading of the reading sensor 51b set to background surface 2 (white) is used. Further, in settings 2 and 3, the read data obtained by the reading of the reading sensor 51a and the read data obtained by the reading of the reading sensor 51b are combined to generate one piece of read data that contains the entire sheet. Note that the relative positional relationship in XY coordinates between the reading sensors 51a and the 51b is stored in the storage 32 in advance, and is referred to at the time of combining.

### (Processing of Switching Background Surface and Printing Processing)

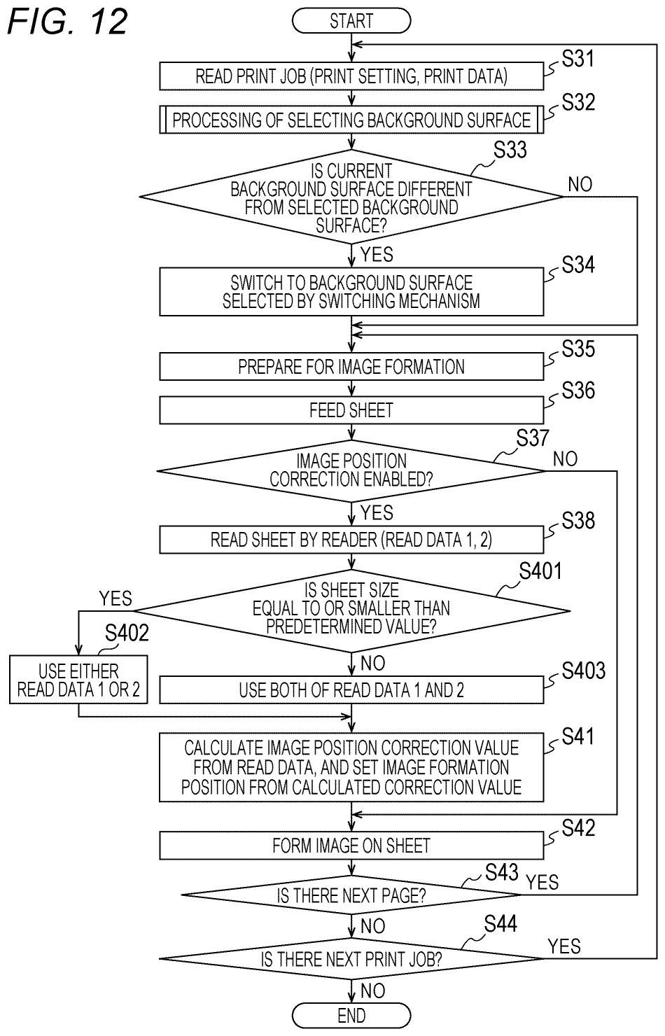

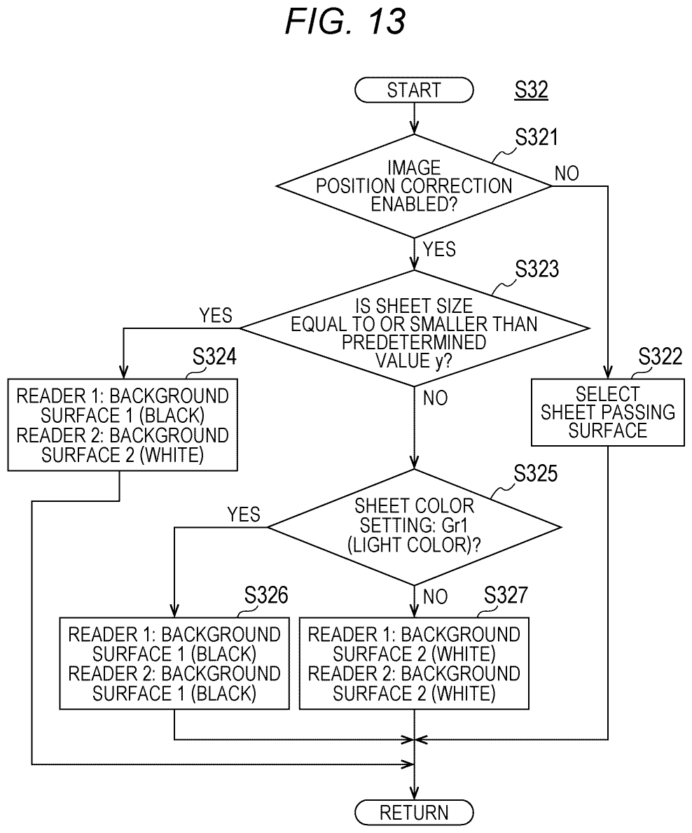

Next, processing of switching the background surface and printing processing that are executed in the image forming system 1000 according to the second embodiment will be described with reference to FIGS. 12 and 13.

### (Step S31)

The process of step S31 corresponds to the process of step S11 in FIG. 7, so that the description thereof is not repeated.

### (Step S32)

The printing controller 111 performs processing of selecting the background surface based on the print setting. This processing will be described with reference to the subroutine flowchart in FIG. 13.

### (Steps S321 and S322)

The processes of steps S321 and S322 are the same as the processes of steps S121 and S122 in FIG. 8, so that the description thereof is not repeated.

### (Step S323)

The printing controller 111 acquires the sheet size (sheet attribute information) on the basis of the print setting. The printing controller 111 determines whether or not the sheet size in the width direction is equal to or smaller than a predetermined value y (e.g., 210 mm). The printing controller 111 advances the processing to step S324 when the sheet size is equal to or smaller than the predetermined value y, and advances the processing to step S325 when it is greater than the predetermined value y.

### (Step S324)

The printing controller 111 selects background surface 1 (black) and background surface 2 (white) for readers 1 and 2, respectively.

### (Step S325)

The printing controller 111 acquires the sheet color (sheet information) in the print setting, and determines whether the sheet color belongs to group 1 (light color) or group 2 (dark color) with reference to the table in FIG. 6. The printing controller 111 advances the processing to step S326 when the sheet color belongs to group 1, and advances the processing to step S327 when it does not belong to group 1 (when it belongs to group 2).

### (Step S326)

The printing controller 111 selects background surface 1 (black) for both the readers 1 and 2.

### (Step S327)

The printing controller 111 selects background surface 2 (white) for both readers 1 and 2. Thus, the printing controller 111 ends the processing in FIG. 13 and returns to processes in step S33 and subsequent steps in FIG. 12.

### (Steps S33 to S38)

The processes of steps S33 to S38 are the same as the processes of steps S13 to S18 in FIG. 8, so that the description thereof is not repeated. In step S38, the two reading sensors 51a and 51b read the conveyed sheet 90 to generate two pieces of read data (read data 1 and read data 2).

### (Step S401)

The printing controller 111 acquires the sheet size on the basis of the print setting. The printing controller 111 determines whether or not the sheet size in the width direction is equal to or smaller than a predetermined value y (e.g., 210 mm). The printing controller 111 advances the processing to step S402 when the sheet size is equal to or smaller than the predetermined value y, and advances the processing to step S403 when it is greater than the predetermined value y.

### (Step S402)

The printing controller 111 uses either read data 1 or read data 2. Specifically, when the sheet belongs to group 1 (light color), read data 1 is used, and when the sheet belongs to group 2 (dark color), read data 2 is used.

### (Step S403)

The printing controller 111 uses both of read data 1 and read data 2 (uses combined data).

### (Step S41)

The reading device controller 112 acquires read data 1, 2 generated by the reading process in step S38 from the reading device 30 and temporarily stores the read data in the storage 12. Then, the reading device controller 112 gives the temporarily stored read data to the correction value calculator 114. The correction value calculator 114 recognizes the ends of the sheet 90 and recognizes the lengths of the four sides and the shape of the sheet 90 by using either read data 1 or 2 or combined data of read data 1 and read data 2 according to the determination in steps S402 and S403.

### (Step S42 to S44)

The processes of steps S42 to S44 are the same as the processes of steps S22 to S24 in FIG. 7, so that the description thereof is not repeated.

As described above, in the second embodiment, during the reading process, the background surface disposed to face the reading sensor 51 and serving as the background of the sheet 90 when the sheet 90 is read is set to a background surface of a color having high contrast with the sheet color of the sheet 90, as in the first embodiment. Alternatively, the read data (read data 1 or read data 2) obtained from reading with the setting of a background surface in a color with such high contrast is selectively used. Therefore, the correction value calculator 114 can accurately recognize the ends of the sheet 90 from the read data. Further, in the second embodiment, in a case where a print job using the sheet 90 with a sheet width equal to or smaller than the predetermined value y and using a sheet of different color is to be executed next, the read data to be used is selected without switching the background surfaces in readers 1 and 2, by which it is possible to increase the accuracy in recognizing the ends of the sheet 90 with the background surface having high contrast. That is, even in a case where a waiting time would occur due to switching of the background surface, the waiting time does not occur, and thus it is possible to suppress a decrease in productivity.

The main configurations of the reading device 30 and the image forming system 1000 including the reading device 30 have been described above for describing the features of the above embodiments, and the configurations of the reading device 30 and the image forming system 1000 including the reading device 30 described above are not limited to the abovementioned configurations, and can be modified in various manners within the scope of the claims. In addition, a configuration included in a general image forming apparatus is not excluded.

The descriptions with reference to FIGS. 7 and 12 indicate an example in which the controller 11 (printing controller 111) of the image forming apparatus 10 primarily performs processing of switching the background surface and generating the read data. However, the configuration is not limited thereto, and the controller 31 of the reading device 30 may primarily perform the processing of switching the background surface and generating the read data. In this case, the reading device 30 acquires, from the controller 11 on the main body side, sheet information (color information and size information) regarding the sheet 90 to be conveyed, and performs control to switch the background surface or selection (S402 and S403 in the second embodiment) of the read data to be used according to the acquired sheet information.

In addition, the descriptions with reference to FIGS. 7 and 12 indicate an example in which sheets having the same sheet color and sheet size are used in one print job, but the present invention is not limited thereto. For example, when colored sheets are mixed in one print job, the processes of step S12 (or S32) and subsequent steps may be performed for each page or for each page in which colored sheet changes.

In addition, an example in which the color information regarding the color of the sheet is set by the user through the operation panel 18 or the like has been described, but the invention is not limited thereto. As another example, a detection sensor that detects a color or a density (brightness) may be disposed in the sheet feeder 25 or the conveyance paths 241 and 341 from the sheet feed tray 255 to the reader 50, and the controller 11 may select the background surface from a detection value of the detection sensor.

In addition, the means and method for performing various kinds of processing in the reading device 30 and the image forming system 1000 according to the above-described embodiments can be implemented by either a dedicated hardware circuit or a programmed computer. The program may be provided by, for example, a computer-readable recording medium such as a USB memory or a digital versatile disc (DVD)-ROM, or may be provided online via a network such as the Internet. In this case, the program recorded on the computer-readable recording medium is commonly transferred to and stored in a storage such as a hard disk. In addition, the program may be provided as independent application software or may be incorporated into software of an apparatus as one function of the apparatus.

While the embodiments of the present invention have been described and illustrated in detail, the disclosed embodiments have been created for purposes of illustration and example only, and not limitation. The scope of the present invention is to be interpreted by the wording of the appended claims.

What is claimed is:

1. A reading device comprising:
a conveyor that conveys a sheet through a conveyance path;
a reader provided with a reading sensor that optically reads the sheet conveyed through the conveyance path; and
a hardware processor that controls the reader, wherein
the reader includes a background section that is disposed to face the reading sensor across the conveyance path, the background section having a background surface serving as a background of the sheet when the sheet is read, and
the hardware processor switches the background surface of the background section on the basis of attribute information of the sheet to be conveyed.

2. The reading device according to claim 1, wherein
the background section includes a plurality of the background surfaces different in color or brightness,
the attribute information of the sheet is information regarding a color of the sheet, and
the hardware processor switches the background surfaces on the basis of the information regarding the color of the sheet.

3. The reading device according to claim 1, wherein the reader reads an end of the sheet conveyed on the background surface.

4. The reading device according to claim 2, wherein
the background section includes a first background surface and a second background surface that is different in brightness from the first background surface, and
the hardware processor switches the background section to the background surface having a greater brightness difference with respect to the color of the sheet to be conveyed.

5. The reading device according to claim 1, wherein
the reader includes a first reading sensor, a second reading sensor,
a first background section disposed to face the first reading sensor, and a second background section disposed to face the second reading sensor, and
the hardware processor switches background surfaces of the first and second background sections on the basis of the attribute information of the sheet.

6. The reading device according to claim 5, wherein
each of the first and second background sections includes a plurality of background surfaces different in color or brightness,
the attribute information of the sheet includes information regarding a size of the sheet, and
the hardware processor switches the background surfaces of the first and second background sections on the basis of the size of the sheet.

7. The reading device according to claim 6, wherein the first reading sensor and the second reading sensor are disposed adjacent to each other in a conveyance direction of the sheet, and are disposed so as to at least partially vary in reading region in a width direction orthogonal to the conveyance direction.

8. The reading device according to claim 7, wherein
the first reading sensor and the second reading sensor have reading regions that overlap each other in the width direction, and
the hardware processor performs control to obtain a combination that provides a prescribed or more brightness difference between the background surface of the first background section and the background surface of the second background section, when the size of the sheet in the width direction is equal to or smaller than a predetermined value.

9. An image forming system comprising:
a sheet feeder that feeds a sheet;
the reading device according to claim 1;
an image former that forms an image on the sheet conveyed from the reading device;
a correction value calculator that calculates a sheet position correction value on the basis of read data obtained by the reading device reading the sheet; and
a printing hardware processor that adjusts a formation position of an image on at least one of a first surface and a second surface of the read sheet on the basis of the sheet position correction value calculated by the correction value calculator.

10. An image forming system comprising:
a sheet feeder that feeds a sheet;
a conveyor that conveys the sheet through a conveyance path;
a reader provided with a reading sensor that optically reads the sheet conveyed through the conveyance path;
an image former that forms an image on the conveyed sheet on a downstream side from the reader in the conveyance path; and
a hardware processor that controls the reader, wherein
the reader includes a background section that is disposed to face the reading sensor across the conveyance path, the background section having a background surface serving as a background of the sheet when the sheet is read, and
the hardware processor switches the background surface of the background section on the basis of attribute information of the sheet to be conveyed.

11. A non-transitory recording medium storing a computer readable control program for controlling an image forming system that includes
a sheet feeder that feeds a sheet,
a conveyor that conveys the sheet through a conveyance path,
a reader provided with a reading sensor that optically reads the sheet conveyed through the conveyance path, and
an image former that is disposed in the conveyance path downstream of the reader and that forms an image on the conveyed sheet,
the reader including a background section that is disposed to face the reading sensor across the conveyance path, the background section having a background surface serving as a background of the sheet when the sheet is read,
the program executing processing of switching the background surface of the background section on the basis of attribute information of the sheet to be conveyed.
